(19) United States
(12) Patent Application Publication
(10) Pub. No.: US 2016/0187291 A1
(43) Pub. Date: Jun. 30, 2016

(54) GLUCOSE TEST STRIP WITH INTERFERENCE CORRECTION

(71) Applicant: Nipro Diagnostics, Inc., Fort Lauderdale, FL (US)

(72) Inventors: John Pasqua, Wellington, FL (US); Francisco Estevez-Labori, Fort Lauderdale, FL (US); Savanna Mayhook, Fort Lauderdale, FL (US)

(21) Appl. No.: 14/985,830

(22) Filed: Dec. 31, 2015

Related U.S. Application Data
(60) Provisional application No. 62/098,516, filed on Dec. 31, 2014.

(51) Int. Cl. G01N 27/416; G01N 27/327

(52) U.S. Cl. CPC G01N 27/4166; G01N 27/3272; G01N 27/3273

(57) ABSTRACT

A test strip comprising a base layer, the base layer having an optional hematocrit anode configured to determine a value corresponding to a hematocrit level of a fluid sample, wherein the hematocrit anode may be coated with a reagent, an interference anode configured to determine a value corresponding to a measurement of an interference caused by one or more oxidizable substances in the sample fluid, wherein the interference anode electrode includes an interference reagent on its surface, a glucose anode, the glucose anode being configured to determine a glucose level in the fluid sample, wherein the glucose anode is covered with a reagent comprising a mediator and an analyte specific enzyme, and one or more cathodes in a cooperative relation with the hematocrit anode, the interference anode, and the glucose anode to measure the hematocrit level, the interference and the glucose level.

### CROSS-REFERENCE TO RELATED APPLICATIONS

The present application claims priority to and benefits of Provisional Application No. 62/098,516, filed Dec. 31, 2014, the disclosure of which is incorporated herein by reference in its entirety.

### FIELD

The present disclosure relates to electrochemical sensors and, more particularly, to systems and methods for electrochemically sensing a particular constituent within a fluid through the use of diagnostic test strips.

### BACKGROUND

Many industries have a commercial need to monitor the concentration of particular constituents in a fluid. In the health care field, individuals with diabetes, for example, have a need to monitor a particular constituent within their bodily fluids. A number of systems are available that allow people to test a body fluid, such as, blood, urine, or saliva, to conveniently monitor the level of a particular fluid constituent, such as, for example, cholesterol, proteins, and glucose. Such systems typically include a test strip where the user applies a fluid sample and a meter that “reads” the test strip to determine the level of the tested constituent in the fluid sample.

### SUMMARY

The present disclosure is directed to an apparatus for measuring a concentration of an analyte in a body fluid. In some embodiments, the systems of the present disclosure may include a test strip on which a reaction between an analyte (such as glucose) in a blood sample and suitable chemistry can take place and a meter in electrical communication with the test strip to measure an electrical signal generated by the reaction and to determine the concentration of the analyte. The test strip may include an electrode system for measuring glucose, which may be covered with a reagent comprising a mediator and analyte specific enzyme. The test strip may further include an electrode system for measuring hematocrit in the blood sample. In some embodiments, the electrodes for measuring the hematocrit may be free of reagent. According to some aspects of the present disclosure, the test strip may also include an electrode system for measuring an interference in the blood sample. In some embodiments, one or more electrodes may be shared between the electrode systems. The hematocrit and interference data may be used to correct the measurement of the analyte.

In some embodiments, a test strip is provided, which comprises a base layer; a hematocrit anode disposed on the base layer and configured to determine a value corresponding to a hematocrit level of the fluid sample, wherein the hematocrit anode may be free of a reagent or may have a reagent disposed over it to aid in providing more consistent spreading of the sample as well as more consistent wetting of the electrode surface; an interference anode disposed on the base layer and configured to determine a value corresponding to a measurement of an interference caused by one or more oxidizable substances in the sample fluid, wherein the interference anode electrode includes an interference reagent on its surface; a glucose anode disposed on the base layer, the glucose anode being configured to determine a glucose level in the fluid sample and is covered with a reagent comprising a mediator and an analyte specific enzyme; and one or more cathodes in a cooperative relation with the anodes to measure hematocrit, interference and glucose levels.

In some embodiments, the strip further comprises a proximal end closer to the fluid sample, and an opposing distal end, wherein the hematocrit anode is most proximal, the glucose anode is most distal, and the interference anode is positioned between the hematocrit anode and the glucose anode. In some embodiments, the one or more cathodes comprises a hematocrit cathode, an interference cathode, and a glucose cathode, all of which are disposed on the base layer in close proximity to the hematocrit anode, the interference anode and the glucose anode respectively. In some embodiments, the one or more cathodes comprises a hematocrit cathode and a second cathode, wherein the second cathode is shared by the interference anode and the glucose anode. In some embodiments, the one or more cathodes is a single cathode shared by the hematocrit anode, the interference anode, and the glucose anode, the single cathode having a full reagent deposited on upon its surface, and wherein the hematocrit level is measured before the measurement of interference or the determination of the glucose level. In some embodiments, the one or more cathodes comprises a hematocrit cathode, the test strip having a measurement path between the hematocrit anode and the hematocrit cathode of from about 0.5 mm to about 5 mm.

In some embodiments, the hematocrit anode and the hematocrit cathode are separated by an electrically isolated region. In some embodiments, a surface of the interference cathode further comprises a reagent containing an analyte specific enzyme. In some embodiments, the mediator may be potassium ferricyanide or ruthenium hexaammine, and the analyte specific enzyme may be glucose oxidase or glucose dehydrogenase. In some embodiments, the hematocrit anode is shared with a drop detect anode, the shared anode being located at a proximal end of the strip, wherein a drop detect cathode is shared with the glucose cathode and the interference cathode, and wherein the strip further comprises at least one isolation island configured to separate regions of reagents from regions of no reagent. In some embodiments, the hematocrit anode is most proximal, the glucose anode is most distal, and the interference anode is positioned between the hematocrit anode and the glucose anode.

In some embodiments, the test strip further comprises at least one hog out region and may further comprise one or more isolation islands, the isolation islands configured to separate regions of the strip with a reagent from regions of the strip without a reagent, or to separate regions of the strip with a reagent from regions of the strip with a different reagent. In some embodiments, the test strip further comprises at least one reagent well and a multi-well spacer in which a reagent is drop dispensed.

In some embodiments, a system for measuring glucose concentration is provided which comprises a test strip and a test meter configured to accept the test strip. The test strip comprises a base layer, a hematocrit anode disposed on the base layer and configured to determine a value corresponding to a hematocrit level of the fluid sample, wherein the hematocrit anode is free of a reagent, an interference anode disposed on the base layer and configured to determine a value corresponding to a measurement of an interference caused by one or more oxidizable substances in the sample fluid, wherein the interference anode electrode includes an interference reagent on its surface, a glucose anode is disposed on the base layer, the glucose anode is configured to determine a glucose level in the fluid sample, and one or more cathodes in a cooperative relation with the anodes to measure hematocrit level, interference and glucose levels. The test meter is further configured to apply a voltage between the anodes and the one or more cathodes, measure current corresponding to hematocrit level, glucose level and interference, and determine a glucose concentration based on the detected currents. In some embodiments, the test strip further comprises at least one hog out region. In some embodiments, the test strip further comprises one or more isolation islands, the isolation islands configured to separate regions of the strip with a reagent from regions of the strip without a reagent, or to separate regions of the strip with a reagent from regions of the strip with a different reagent.

In some embodiments, the hematocrit anode is shared with a drop detect anode which is located at a proximal end of the strip, this shared anode being the first electrode that a fluid sample will encounter. In some embodiments, the drop detect cathode also serves as the glucose and interference cathode. In some embodiments, the hematocrit cathode will be covered with a glucose reagent and the hematocrit anode will be reagent free. In some embodiments, the strip further comprises isolation islands (i/i) and hog out regions. The i/i areas on the strip separate areas of no reagent from areas of reagent, or in some embodiments the i/i areas separate regions of two different reagents.

In some aspects of the present disclosure, a method for measuring an amount of glucose in a sample of blood. The method comprises measuring a hematocrit value in a sample of blood placed onto a test strip, measuring an amount of glucose in the sample, determining an amount of interference from one or more interferents present in the sample, and calculating, with the meter, a final glucose value in the sample by adjusting the measured amount of glucose with both the measured hematocrit value and the determined amount of interference. In some embodiments, the test strip comprises a base layer having a hematocrit anode configured to determine a value corresponding to a hematocrit level of the fluid sample, wherein the hematocrit anode is free of a reagent, an interference anode configured to determine a value corresponding to a measurement of an interference caused by one or more oxidizable substances in the sample fluid, wherein the interference anode electrode includes an interference reagent on its surface, a glucose anode configured to determine a glucose level in the fluid sample, and one or more cathodes in a cooperative relation with the anodes to measure hematocrit level, interference and glucose levels. In some embodiments the hematocrit value may be measured by applying a voltage with the meter to a pair of hematocrit electrodes, wherein the amount of glucose is measured by applying a voltage with the meter to a pair of glucose electrodes, and wherein the amount of interference is determined by applying a voltage with the meter to a pair of interference electrodes. In some embodiments, the test strip is inserted into a test meter, the test meter being configured to accept the test strip, the test meter further configured to (1) apply a voltage between the anodes and the one or more cathodes, (2) measure current corresponding to hematocrit level, glucose level and interference, and (3) determine a glucose concentration based on the detected currents.

### BRIEF DESCRIPTION OF THE DRAWINGS

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1 is a side view of a test strip according to some embodiments of the present disclosure;

FIG. 2A illustrates a top plan view of a test strip according to some embodiments of the present disclosure;

FIG. 2B illustrates a top plan view of the test strip of FIG. 2A, showing a dielectric insulating layer;

FIG. 2C illustrates a top plan view of a test strip according to some embodiments of the present disclosure;

FIG. 2D illustrates a top plan view of the integrated test strip of FIG. 2C, showing a dielectric insulating layer;

FIG. 3A illustrates a top plan view of a test strip according to some embodiments of the present disclosure;

FIG. 3B illustrates a top plan view of the integrated test strip of FIG. 3A, showing a dielectric insulating layer;

FIG. 4A illustrates a top plan view of a test strip according to some embodiments of the present disclosure;

FIG. 4B illustrates a top plan view of the test strip of FIG. 4A, showing a dielectric insulating layer;

FIG. 5A and FIG. 5B illustrates a meter according to some embodiments of the present disclosure;

FIG. 6A shows a top view of a test strip inserted into a meter according to some embodiments of the present disclosure;

FIG. 6B is a side view of a test strip inserted into a meter according to some embodiments of the present disclosure; and

FIG. 7 illustrates a top view of a test strip with a long Hct path according to some embodiments of the present disclosure.

FIG. 8 illustrates a top view of a test strip with a long Hct path according to some embodiments of the present disclosure.

FIG. 9 illustrates a top view of a test strip with a common Hct, glucose and interference cathode according to some embodiments of the present disclosure.

FIG. 10 illustrates a top view of a test strip with a well design for reagent containment according to some embodiments of the present disclosure.

FIGS. 11A and 11B present a flow chart showing a test routine according to some embodiments of the present disclosure.

FIG. 12 presents a flow chart showing an algorithm for correcting glucose measurements according to some embodiments of the present disclosure.

FIG. 13 presents a flow chart showing a process for correcting glucose measurements according to some embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It being understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments may be practiced without these specific details. For example, systems, processes, and other elements in the disclosure may be shown as components in block diagram form in order not to obscure the embodiments in unnecessary detail. In other instances, well-known processes, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

In accordance with the present disclosure provided herein are electrochemical sensors developed for measuring a concentration of an analyte, such as glucose, in a fluid sample, such as blood. It should be noted that the systems and methods of the present disclosure will be described in connection with measuring a concentration of glucose in blood, the systems and methods of the present disclosure can be used to measure other analytes in a variety of fluids. In some embodiments, the analytes may be any analyte of interest that has a corresponding specific and commercially available oxidase or dehydrogenase that may be measured using a diagnostic strip, such as uric acid, lactic acid, ethanol, beta hydroxybutyric acid, gamma hydroxybutyric acid, phenylalanine and bilirubin.

In some embodiments, the systems of the present disclosure may include a test strip on which a reaction between an analyte (such as glucose) in a blood sample and suitable chemistry can take place and a meter in electrical communication with the test strip to measure an electrical signal generated by the reaction and to determine the concentration of the analyte. The test strip includes an electrode system for measuring an analyte such as glucose. In some embodiments, one or more of the electrodes may be covered with a reagent comprising a mediator and/or an analyte specific enzyme. In some embodiments, the glucose cathode, whether it is dedicated or shared, may be covered with reagent (enzyme and mediator). In some embodiments, the glucose cathode may be covered with mediator only (interference reagent). The test strip may further include an electrode system for measuring hematocrit in the blood sample. In some embodiments, the electrodes for measuring the hematocrit may be free of reagent. In some embodiments, the hematocrit electrodes may have a reagent disposed on either or both of the hematocrit anode and hematocrit cathode. The reagent may aid in the spreading of sample and in the wetting of the hematocrit electrode surfaces. The reagent may comprise a low amount of a buffer, small amounts of a surfactant, and polymers. The surfactant may be, for example, Triton X-100 and/or dioctyl sulfosuccinate. In some embodiments, a test strip is provided, which comprises a base layer; an interference anode disposed on the base layer and configured to determine a value corresponding to a measurement of an interference caused by one or more oxidizable substances in the sample fluid, wherein the interference anode electrode includes an interference reagent on its surface; a glucose anode is disposed on the base layer, the glucose anode electrode is configured to determine a glucose level in the fluid sample; and one or more cathodes in a cooperative relation with the anodes to measure interference and glucose level.

According to some aspects of the present disclosure, the test strip may also include an electrode system for measuring an interference in the blood sample. In some embodiments, one or more electrodes may be shared between the electrode systems. The hematocrit and interference data may be used to correct the measurement of the analyte. In some embodiments, all of the anodes may be paired with a cathode for functionality. The number of electrodes needed depends on which functions can be shared by the electrodes. In some embodiments, the strip has at least five detection/measurement functions: drop detect, fill detect, hematocrit measurement, interference measurement, and glucose measurement. In some embodiments, there is one anode that serves as the drop detect and Hct anode. In some embodiments, there is a shared fill, glucose and interference anode, and a shared glucose and interference cathode. In some embodiments, the drop detect cathode function may be shared with the Hct cathode or the shared glucose and interference cathode. In some embodiments, there is an electrode that functions as a shared Hct, glucose and interference cathode. In some embodiments, the test strip may have a width of from about 5.0 mm to about 9 mm, or of from about 5.5 mm to about 8.7 mm.

In some embodiments, a test strip is provided, which comprises a base layer; an interference anode disposed on the base layer and configured to determine a value corresponding to a measurement of an interference caused by one or more oxidizable substances in the sample fluid, wherein the interference anode electrode includes an interference reagent on its surface; a glucose anode is disposed on the base layer, the glucose anode electrode is configured to determine a glucose level in the fluid sample; and one or more cathodes in a cooperative relation with the anodes to measure interference and glucose level.

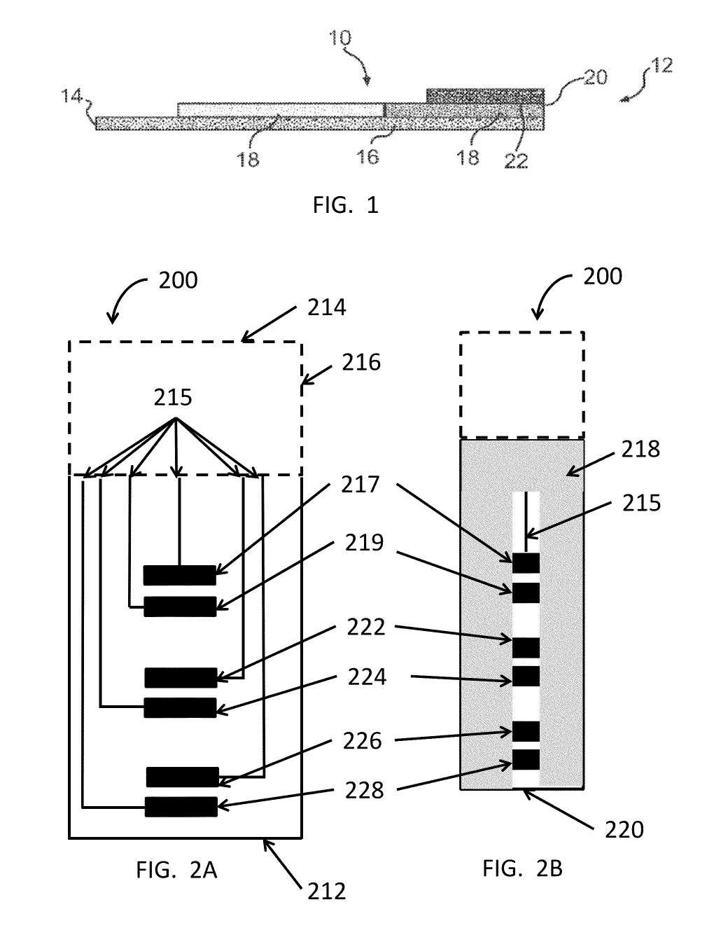

FIG. 1 illustrates a general cross-sectional view of an embodiment of a test strip 10 consistent with the present disclosure. In some embodiments, the test strip of the present disclosure can be formed using materials and methods described in commonly owned U.S. Pat. No. 6,743,635 and U.S. patent application Ser. No. 11/181,778, which are hereby incorporated by reference in their entireties. In some embodiments, the test strip 10 may include a proximal end 12, a distal end 14, and is formed with a base layer 16 extending along the entire length of test strip 10. For purposes of this disclosure, “distal” refers to the portion of a test strip further from the fluid source (i.e., closer to the meter) during normal use, and “proximal” refers to the portion closer to the fluid source (e.g., a fingertip with a drop of blood for a glucose test strip) during normal use. Base layer 16 may be composed of an electrically insulating material and has a thickness sufficient to provide structural support to test strip 10. In some embodiments, the base layer 16 includes an electrically conductive layer covered with an electrically insulating material.

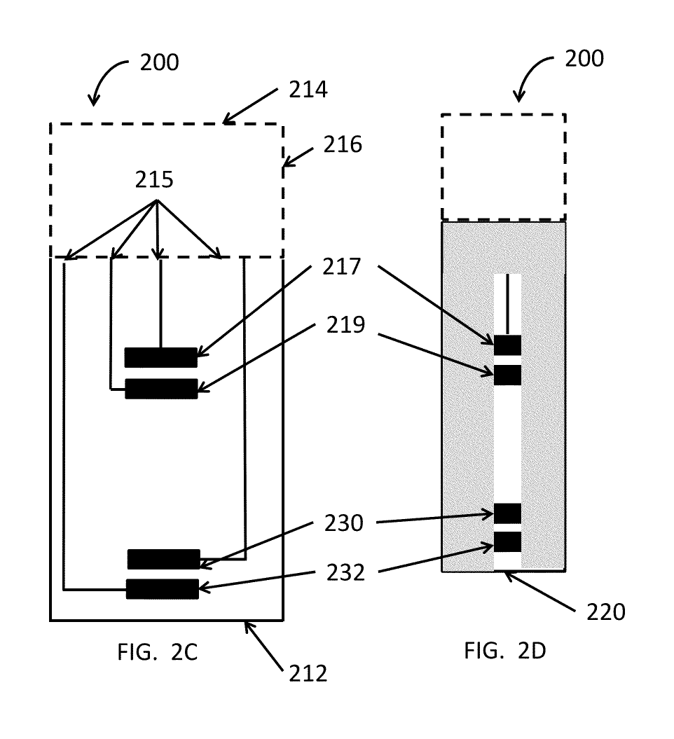

Referring to FIGS. 2A-2B, in some embodiments, a conductive pattern may be formed by laser ablating the electrically conductive material from the base layer 16 to expose the electrically insulating material underneath. Other methods may also be used to dispose the conductive pattern on the base layer, such as ablating away sputtered metal deposited on a surface of the nonconductive substrate using focused lasers (laser engraving). In some embodiments, a laser resistant mask may be used that has patterned openings in the shape of the desired conductive pattern. A high energy laser burst may ablate the conductive material away from the insulting substrate surface. This process is often called Masked Excimer Laser Ablation or Broad Field Laser Ablation and often employs a high powered UV laser. In some embodiments, conductive inks (carbon inks are common) may be deposited over a nonconductive substrate to form a pattern. Conversely, insulating inks can be deposited over a conductive surface to create a conductive pattern. The conductive pattern may include a plurality of electrodes disposed on base layer 16 near proximal end 12, and a plurality of conductive traces electrically connecting the electrodes to a plurality of electrical strip contacts (not shown) at the distal end 14 to enable the meter to read current between the electrodes. In some embodiments, the plurality of electrodes may include a working electrode, a counter electrode, and fill-detect electrodes. In some embodiments, the conductive pattern may include multiple working electrodes for measuring different analytes, constituents or characteristics of the body fluid being tested. A constituent can be any defined component of the blood such as glucose, red blood cells, plasma, proteins, salts, etc. An analyte can be a compound that is the object of a chemical (electrochemical, immunochemical) analysis or measurement. Common analytes can be glucose, cholesterol, hormones, etc. A characteristic can be a property or quality of the blood that is reflective of its constituents in the aggregate. Some blood characteristics of interest are temperature, conductivity (resistivity) hematocrit, viscosity, etc. In some embodiments, the test strip 10 may have at least six electrodes, in some embodiments the test strip 10 may have five or less electrodes, and in some embodiments the test strip 10 will have a plurality of electrodes, some of which may be shared.

Referring back to FIG. 1, a dielectric insulating layer 18 may be formed over the conductive pattern along a portion of the test strip 10 between the measuring electrodes (not shown) and the plurality of electrical strip contacts (not shown) in order to prevent scratching, and other damage, to the electrical connection. As seen in FIG. 1, the proximal end 12 of test strip 10 may include a sample receiving location, such as the capillary chamber 20 configured to receive a user's fluid sample. The capillary chamber 20 may be formed in part through a slot formed between a cover 22 and the underlying measuring electrodes formed on base layer 16. The capillary chamber 20 has a first opening in the proximal end 12 of the test strip 10 and a second opening for venting the capillary chamber 20. The capillary chamber 20 may be dimensioned so as to be able to draw the blood sample in through the first opening, and to hold the blood sample in the capillary chamber 20, by capillary action. The test strip 10 may include a tapered section (not shown) that is narrowest at the proximal end, in order to make it easier for the user to locate the first opening and apply the blood sample.

Referring to FIG. 2A, in some embodiments, an integrated test strip 200 may have a base layer 216 and a plurality of electrodes 217, 219, 222, 224, 226, 228 that make up at least three systems on the test strip 200. For example, the first system includes a first set of electrodes or hematocrit electrodes that include a first counter electrode (hematocrit cathode) 226 and a first working electrode (hematocrit anode) 228. The second system includes a second set of electrodes or interference electrodes, such as a second counter electrode (interference cathode) 222 and second working electrode (interference anode) 224 disposed in the capillary chamber 220 (see FIG. 2B). The third system includes a third set of electrodes or glucose electrodes, such as a third counter electrode (glucose cathode) 219 and a third counter electrode (glucose anode) 217. In some embodiments, the electrodes 217, 219, 222, 224, 226, 228 may be at least partially disposed in the capillary chamber (see FIG. 2B) to expose the electrodes to the blood sample in the chamber. Further, conductive traces 215 electrically connect the plurality of electrodes 217, 219, 222, 224, 226, 228 disposed on base layer 216 near the proximal end 212 to a plurality of electrical contacts (not shown) located on the distal end 214 of the test strip 200.

The three systems of the test strip 200, the first system having hematocrit electrodes 226, 228, the second system having interference electrodes 222, 224 and the third system having glucose electrodes 217, 219 are further explained below. In some embodiments, the hematocrit electrodes are located closest to the entry to the chamber (proximal end), followed by the interference electrodes, and then by glucose electrodes. As is discussed below, in some embodiments the hematocrit electrodes are reagent free, but alternatively in some embodiments the hematocrit electrodes may be coated with reagent. If a small amount of ionic components in either the glucose or interference reagent, such as the mediator or buffer is carried into the hematocrit area, it may interfere with the hematocrit measurement. Similarly, in some embodiments, the interference cathode does not include an enzyme. In some embodiments, the interference reagent may thus be proximal to the glucose reagent because if any of the enzyme washed onto the interference area it might render the interference signal partially dependent on the glucose level and eliminate its effectiveness. However, the order of the tests may be changed. In some embodiments, the order does not matter if the reagents were so constituted that there was not significant mobility of the ions or enzymes from one region to another during the time of a test. That is, the reagent can wet and become active without truly dissolving and migrating.

The hematocrit electrodes 226, 228 may be spaced at a predetermined distance such that hematocrit level may be determined in the blood sample by measurement of electrical impedance or current between the two hematocrit electrodes in the capillary chamber. In some embodiments, the hematocrit electrodes 226, 228 are free of reagent. The use of a reagent free hematocrit electrodes can also allow for the use of a simpler electrical measurement technique, such as pulsed DC, rather than a more complicated electrical measurement technique.

The requirement that the hematocrit measurement electrodes 226, 228 be free of deposited reagent does not limit the placement relative to other electrodes on the test strip. The two hematocrit electrodes 226, 228 could be the first two electrodes traversed by the blood flowing into the strip or the last two.

It is possible the hematocrit measurement electrodes 226, 228 can also be placed between other electrodes on the test strip 200 that are used for other purposes. Further, the hematocrit electrodes 226, 228 may be placed adjacent to each other or apart from each other with other electrodes in between the two.

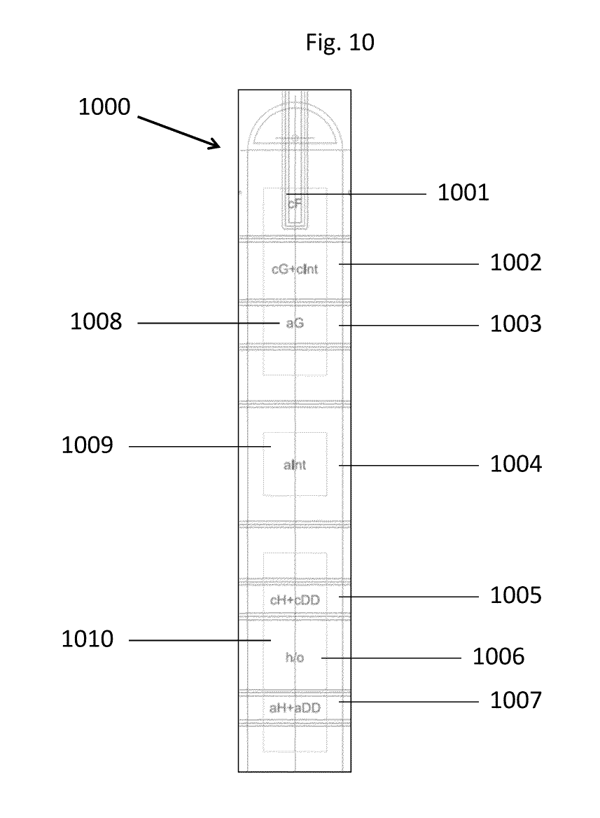

In some embodiments, the hematocrit electrodes 226, 22.8 free of reagent may be placed next to each other to ensure that the blood sample does not get exposed to reagent during hematocrit measurement. Reagent on the electrodes can impact the hematocrit measurement. It is preferable that the hematocrit cathode be free of reagent, but it is not necessary. In some embodiments, the test strip further comprises isolation islands. Isolations islands are regions where the sputtered metal film is laser ablated off of the plastic substrate below is exposed. This creates a hydrophobic region that inhibits reagent from spreading over it and so isolates areas that have no reagent from areas that have reagent. In some embodiments, isolation islands can prevent the mixing of two different types of reagents such as glucose reagent and interference reagent. For example, in FIG. 10 (discussed more fully below) there is disclosed a strip 1000 that has a multi-well spacer into which reagent is drop dispensed. These wells help separate regions of the strip from each other. As the amount, distribution and solubility of reagent may differ slightly from strip to strip, having electrodes with no reagent may lead to more accurate and precise hematocrit measurements. In some embodiments, the placement of the hematocrit electrodes 226, 228 can be potentially advantageous where there are other intervening electrodes between the two hematocrit electrodes that can allow for a longer measurement path and greater discrimination between hematocrit levels than a shorter path would allow. A short path can be anything less than 2 mm between the hematocrit anode and cathode and only has an electrically isolated area between them. A long path can be anything longer than 2 mm and can include other electrodes between hematocrit anode and cathode. In comparison of a small path (0.5 mm-2 mm) and a long path (2 mm-5 mm), testing has shown that a longer path length increases hematocrit resolution and therefore improves precision.

In some embodiments, the hematocrit electrodes may be separated by an elegy electrically isolated region. In some embodiments, the distance between electrodes 226 and 228 may be approximately about 1 mm. The distance between the hematocrit anode and cathode can range between about 1 mm and 5 mm, inclusive.

The second or interference system includes the interference anode 224 and the interference cathode. In some embodiments, the interference anode 224 has deposited upon its surface a reagent that contains a redox mediator, but is free of an analyte specific enzyme (interference reagent) to correct for interfering substances that directly react with the surface of the analyte measuring anode electrode 224 or with the mediator. The interference cathode 222 may be coated with the same reagent as the interference anode or with a reagent containing the analyte specific enzyme and mediator (full reagent).

The glucose and/or interference cathode may be covered with glucose reagent which consists of enzyme and mediator. The electrochemical reaction occurring at the cathode does not involve the enzyme, just the mediator: Fe3+(CN)6+e−→Fe2+(CN)6. This serves to electrically balance the reverse reaction occurring at the anode (e− is an electron). At the interference anode, which contains no enzyme, the Fe2+(CN)6 (ferrocyanide) is generated only from the reaction of oxidizable compounds such as ascorbic acid and uric acid directly with Fe3+(CN)6 (ferricyanide). At the glucose anode the same reactions that are described for the interference anode are also occurring, but in addition there is more ferrocyanide being generated from the action of the enzyme on glucose. Therefore, the difference between the signals from the glucose and interference anodes results in just the signal from glucose. So only the glucose and/or interference cathode contain the full reagent with both mediator and enzyme. The interference anode is covered with reagent that contains only mediator.

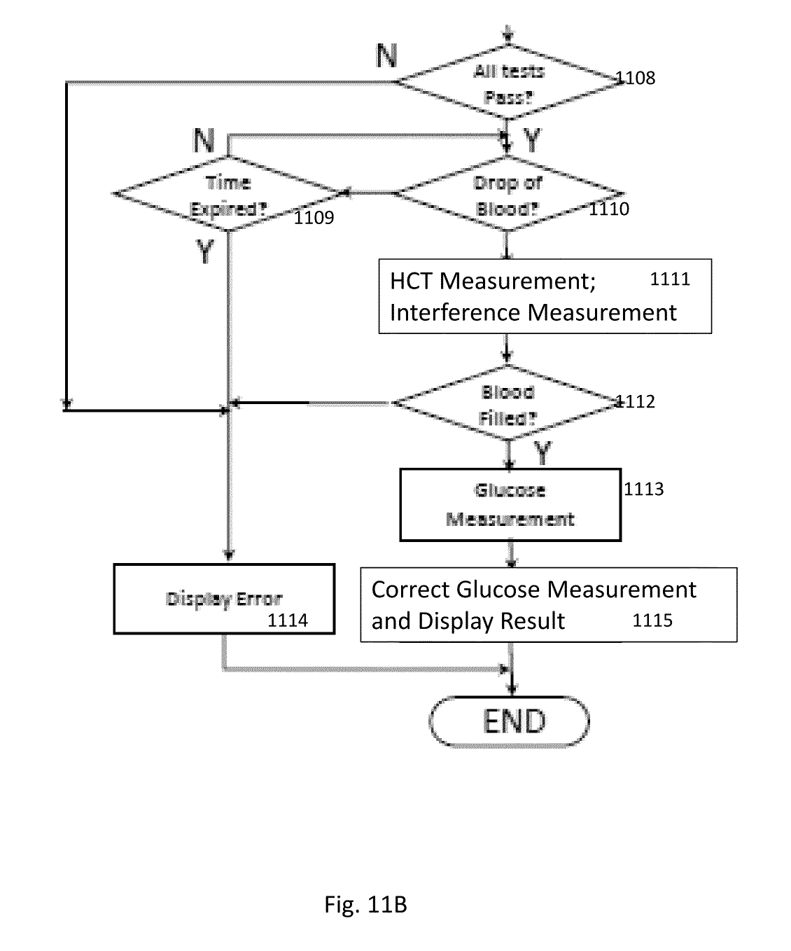

Referring to the second system of FIG. 2A and FIG. 2B, it is possible to use the signal generated by the interference anode 224 in different ways to correct for oxidizable interferents. The signal from this anode can be used to correct for any change in background current that occurs in strips stored in the vial over time. That is, it can improve the stability of the strip and thus increase its shelf-life. In some embodiments, to correct the analyte value, a mathematically modified interference current may be subtracted from the analyte specific current to then generate a corrected analyte value, which is further described in FIG. 12.

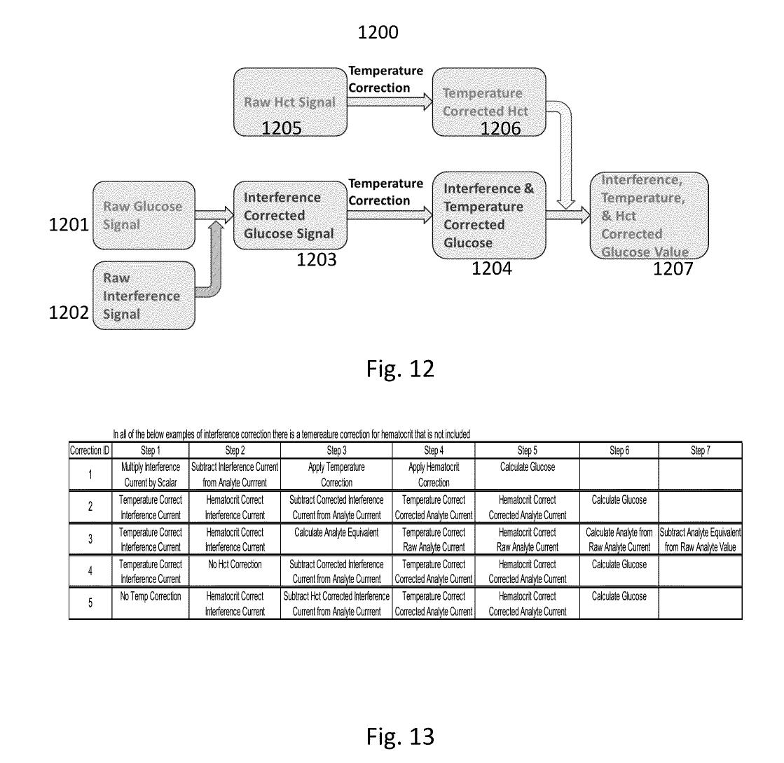

Referring to the second system of FIG. 2A, it is possible to scale the interference current in a test strip lot specific manner so the subtraction can be appropriate for each batch of test strips, as may be further seen in FIG. 13.

The third system of FIG. 2A may include a working anode electrode 219 and counter cathode electrode 217. These electrodes may be covered in their entireties by the full reagent layer to enable the level of glucose in the blood sample to be determined electrochemically. The reagent layer may include an enzyme specific for glucose, such as glucose oxidase, and a mediator, such as potassium ferricyanide or ruthenium hexaammine. The reagent may also include other components, such as buffering materials (e.g., potassium phosphate), polymeric binders (e.g., hydroxypropyl-methyl-cellulose, sodium alginate, microcrystalline cellulose, polyethylene oxide, hydroxyethylcellulose, and/or polyvinyl alcohol), and surfactants (e.g., Triton X-100 or Surfynol 485). With these chemical constituents, the reagent layer reacts with glucose in the blood sample in the following way: The glucose oxidoreductase initiates a reaction that oxidizes the glucose to gluconic acid and in the process reduces the ferricyanide to ferrocyanide. When an appropriate voltage is applied to the working electrode, relative to the counter electrode, the ferrocyanide is oxidized back to ferricyanide, thereby generating a current that is related to the glucose concentration in the blood sample.

Referring to FIG. 2A, it should be noted that the electrodes 217, 219, 222, 224, 226, 228 can be located in any particular order and/or location on the test strip 200. In some embodiments, the order (proximal to distal where proximal is the blood entry portion) may be hematocrit, interference then glucose. This order is impacted by blood flow. Any mediator, salt or buffer in the interference or working reagent that washes or back diffuses over the hematocrit anode may compromise the hematocrit measurement. Any enzyme in the glucose reagent that washes or back diffuses over the interference anode may compromise the interference measurement. That being said, if the reagents are properly constituted there could be very little flow or back diffusion over the sensitive electrodes during the time course of the test so that in theory any order is passible. In some embodiments, the fill electrode may be the most distal electrode, but other placements of the interference electrodes 222, 224 are possible. For example, the most distal electrode could be a shared fill and Hct cathode. The glucose signal is also dependent on the size of the glucose cathode that is covered since there has to be sufficient reactive area on the cathode to sink the current produced by the anode. This is especially true for samples that have high levels of glucose. For example, one other placement of the interference anode 224 can be upstream of the analyte measuring electrode interference cathode 222. If the solubility properties of the full (enzyme & mediator) and working reagent along with the timing of the analyte and interference measurements are properly adjusted, then, among other things, the interference anode 224 can be placed either upstream or downstream from the interference cathode 222.

FIG. 2B illustrates the top plan view of the first configuration of the integrated test strip 200 of FIG. 2A. FIG. 2B shows the dielectric insulating layer 218 formed over the conductive pattern, where conductive traces 315 are electrically connecting the plurality of electrodes 217, 219, 222, 224, 226, 228 to a plurality of electrical contacts (not shown). It is also noted that the plurality of electrodes 217, 219, 222, 224, 226, 228 are in communication with the capillary chamber 220.

Referring to FIG. 2C and FIG. 2D, in some embodiments, there may be less than three systems on the test strip 200. For example, and not limited by any particular embodiment, as seen in FIG. 2C there may only be two systems, such as a glucose anode 219 and a paired glucose cathode 217, and an interference anode 232 with a paired interference cathode 230. Further, as described below, the systems may share an electrode to further reduce the number of electrodes on the test strip. In some embodiments the systems can have shared functions. For example, in some embodiments there may be no hematocrit measurement system on the test strip 200. Further, the glucose system and the interference system may share a cathode, such that the electrodes are as following: a glucose anode 219, a shared glucose/interference cathode 230, an interference anode 232, and a fill detect cathode 217. By way of a non-limiting example, hematocrit effects may be mitigated using information from glucose decay curves. Glucose decay curve (current vs. time) characteristics, such as initial slope, curvature, current magnitude at a selected time, slope at a selected time, area under the decay curve, and the presence and timing of inflection points, may be mathematically manipulated to generate a signal in which the effect of hematocrit is greatly reduced or completely eliminated.

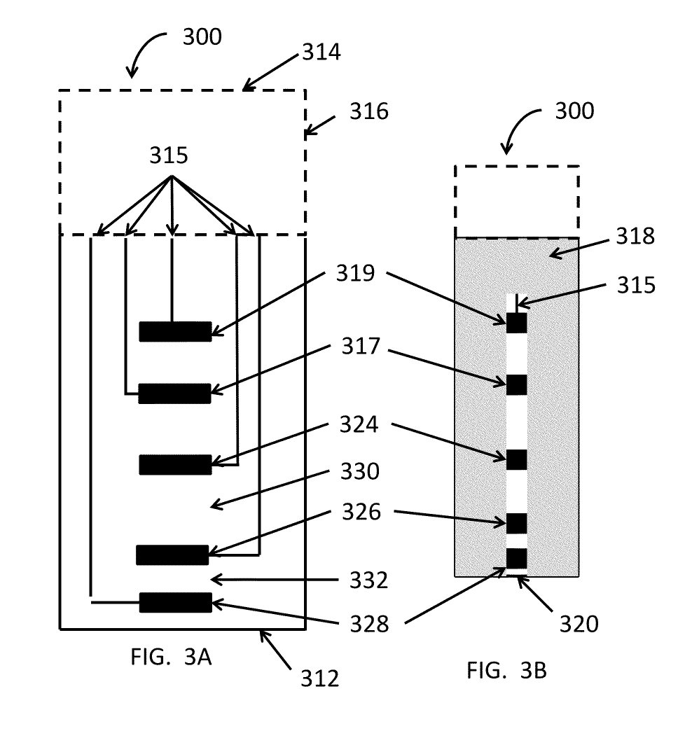

In reference to FIG. 3A and FIG. 3B, in some embodiments, in a test strip 300 used to measure an analyte concentration in a biological fluid, the interference system and the glucose system share the cathode 317.

The first system of FIG. 3A includes hematocrit electrodes 326, 328 and define a path that is dedicated to the measurement of hematocrit in the test strip 300. These electrodes may be reagent free, that is, not covered by the reagent. The second system includes an interference anode 324 having a reagent with only a mediator and positioned distal to the hematocrit cathode 326. The interference anode 324 can be optionally separated by a reagent isolation island 330 from the hematocrit cathode 326 to ensure that the hematocrit electrodes are free of any reagent. However, as noted above. The glucose cathode and interference cathode are combined into a single cathode (or a glucose and interference cathode 317) that includes a reagent with an enzyme and a mediator. Since there is a large excess of ferricyanide in the chemistry, the electric potentials of the glucose and the interference cathodes are independent of the concentrations of analyte and interfering substances in the sample. Therefore, the glucose and interference cathodes can be combined into a single electrode allowing easier manufacturing process and a smaller strip design which at the same time allow the use of smaller samples with all the associated benefits. The third system of FIG. 3A includes a glucose anode 319 but there is no separate glucose cathode, but instead the interference system and the glucose system share the cathode 317.

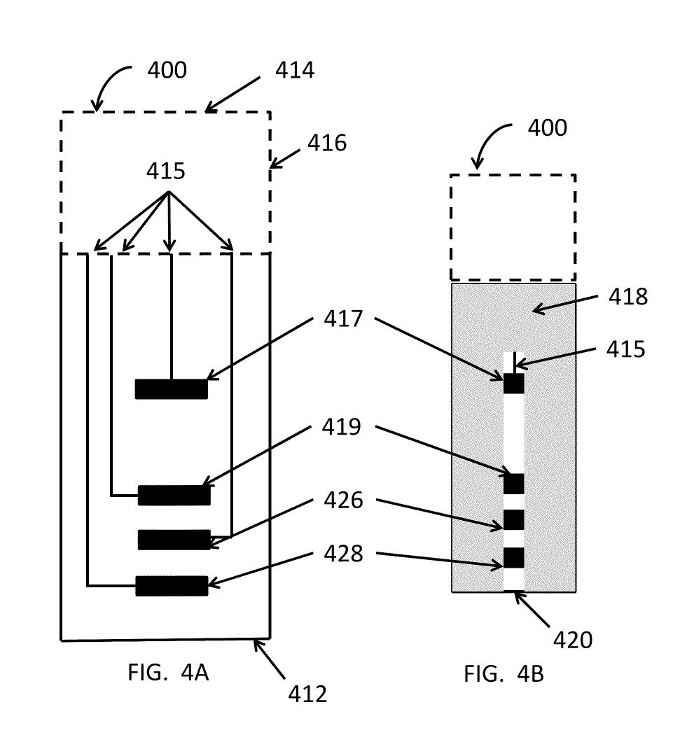

In reference to FIG. 4A and FIG. 4B, in some embodiments, the three systems of electrodes may share the same cathode (or a glucose, interference and hematocrit cathode 417). Any relative configuration of cathode to the anode might work. The hematocrit test is done at a different time than the glucose and interference tests so where the hematocrit anode is positioned relative the cathode is unimportant. The interference tests and glucose tests can be run at the same time. For example, if the glucose anode is between the interference anode and the common cathode the electric field between the glucose anode and cathode might interference with the electric field between the interference anode and common cathode. In some embodiments, the common cathode may lie between the glucose and interference anodes (or working electrodes). But since electrochemistry occurs more at the surface of the electrodes, it may be that the electric fields do not play such an important role. Therefore, it is possible that any configuration of electrodes may work.

In reference to FIG. 4A and FIG. 4B, the electrode systems may include a hematocrit working electrode (anode) 428, an interference working electrode (anode) 426, a glucose working electrode (anode) 419, and a common cathode 417 with full reagent.

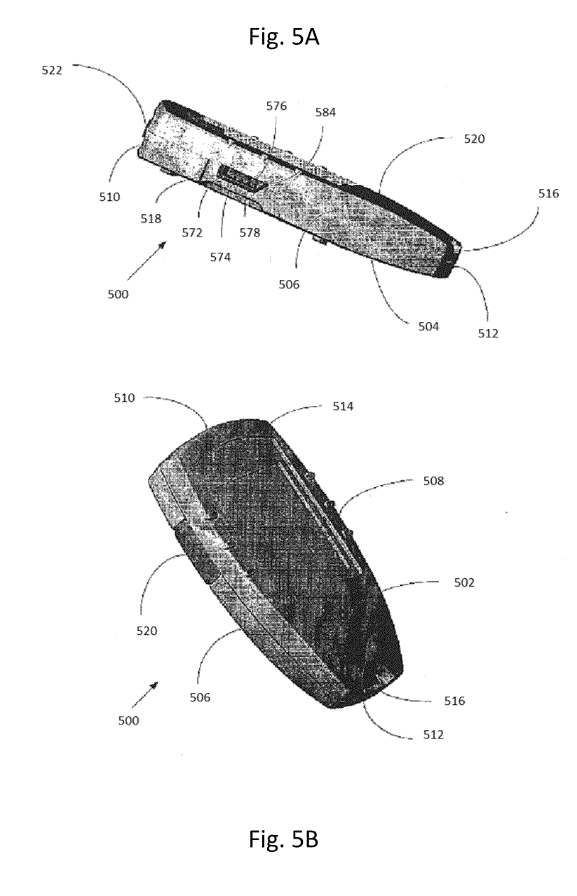

FIG. 5A and FIG. 5B illustrates a meter used to measure the glucose level in a blood sample. In some embodiments, the meter 500 has a size and shape to allow it to be conveniently held in a user's hand while the user is performing the glucose measurement. Meter 500 may include a front side 502, a back side 504, a left side 506, a right side 508, a top side 510, and a bottom side 512. The front side 502 may include a display 514, such as a liquid crystal display (LCD). A bottom side 512 may include a strip connector 516 into which test strip 10 can be inserted to conduct a measurement.

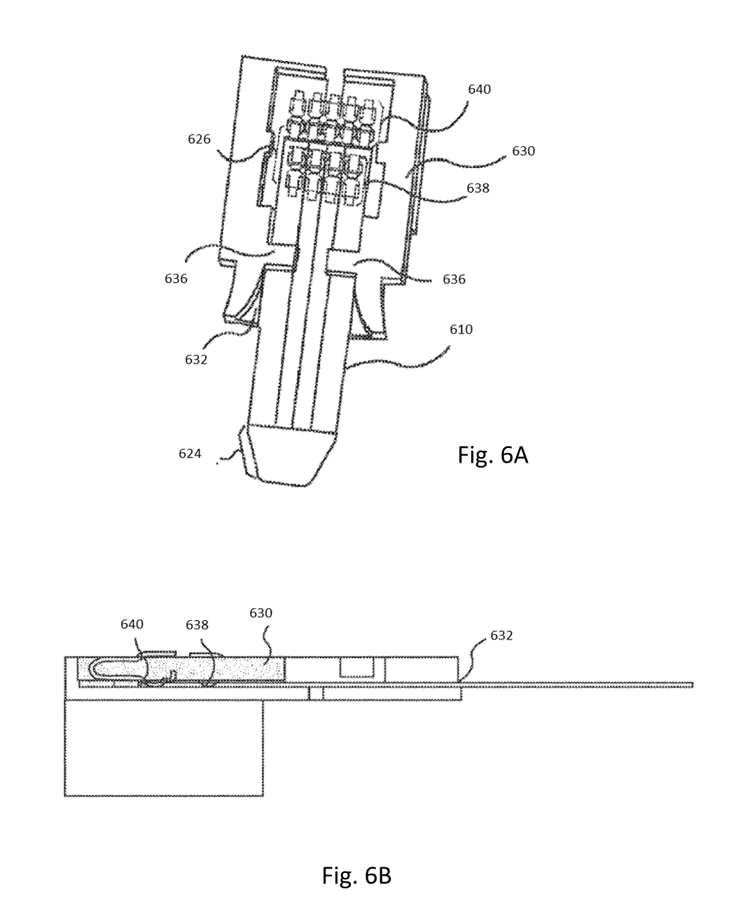

FIGS. 5A, 5B, 6A and 6D illustrate an exemplary embodiment of an analyte meter that may be used in connection with test strips of the present disclosure. Referring to FIG. 5A and FIG. 5B, the left side 506 of meter 500 may include a data connector 518 into which a removable data storage device 520 may be inserted, as necessary. The top side 510 may include one or more user controls 522, such as buttons, with which the user may control meter 500, and the right side 508 may include a serial connector (not shown).

FIG. 6A illustrates a top perspective view of a test strip 610 inserted within a meter connector 30 consistent with the present disclosure. Test strip 610 includes a proximal electrode region 624, which contains the capillary chamber and measuring electrodes, as described above. Proximal electrode region 624 may be formed to have a particular shape in order to distinguish to the user the end receiving a fluid sample from distal strip contact region 626. Meter connector 630 includes channel 632 extending out to a flared opening for receiving the test strip 610. Meter connector 630 may further include tangs 636 extending a predetermined height above the base of channel 632. The predetermined height of tangs 636 is selected to limit the extent, such as through a corresponding raised layer of test strip 610, to which a test strip 610 can be inserted into channel 632. Meter connector 630 may include a first plurality of connector contacts 638, disposed closer to the proximal end of meter connector 630, which are configured to contact the electrical strip contacts 619 upon insertion of the test strip 610 into the meter connector 630. In some embodiments, the test strip control circuit reader 640 may be disposed closer to the distal end of meter connector 630 to communicate with the test strip control circuit 650. In some embodiments, the meter may be provided with one or more GPIO lines for communication with the IC. The one or more GPIO lines may replace digital coding lines (typically 3-5) utilizing GPIOs.

FIG. 6B illustrates a general cross-sectional view of a test strip inserted within meter connector 630 of FIG. 6A, consistent with the present disclosure. Channel 632 depicts a proximal row of connectors comprising a plurality of connector contacts 638 for connection the electrical strip contacts 619 upon insertion of the test strip 610 into the meter connector 630.

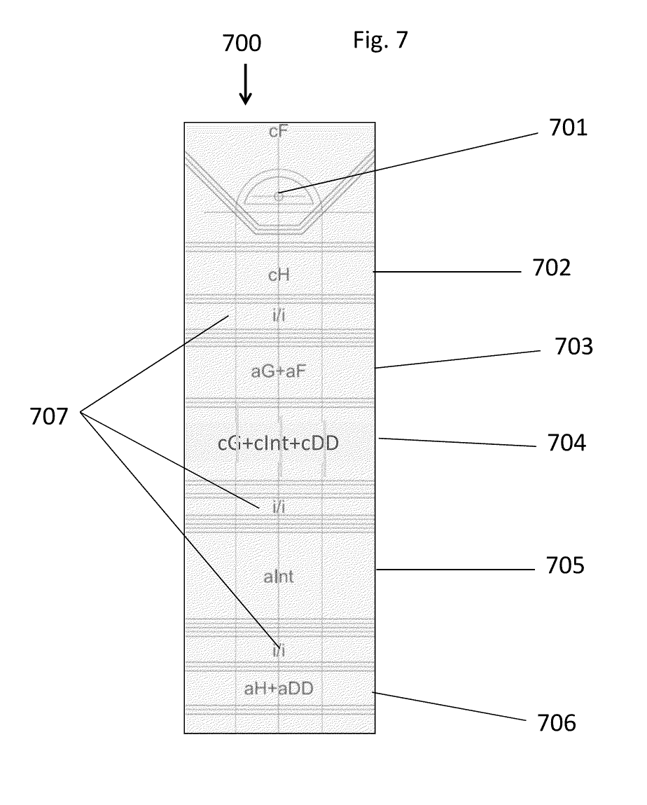

Referring to FIG. 7, illustrated is an embodiment of a diagnostic strip 700 with a long Hct path, which may be provided for better resolution of the results. The strip 700 comprises a fill detect cathode 701, a hematocrit cathode 702, a shared glucose and fill anode 703, a shared glucose, interference and drop detect cathode 704, an interference anode 705 which may be coated with reagent only (mediator only), and a shared drop detect and hematocrit anode 706. The shared hematocrit drop detect anode 706 is at the proximal end of the strip and is the first electrode that the blood will encounter. Once the strip 700 is placed in the meter (not pictured) it is monitored for the addition of sample by measuring the current between the drop detect anode 706 and cathode 704. The drop detect cathode 704 also serves as the glucose and interference cathode. Once the sample is detected, it has a fixed amount of time to reach the fill cathode 701 at the distal end of the sample well of the strip 700. If this timing criterion is satisfied, then the remainder of the testing sequence will commence. In the strip 700 configuration demonstrated by FIG. 7, the all of the measurements (hematocrit, glucose and interference) will take place after fill detect. In some embodiments, all three measurements cannot take place simultaneously. The preferred sequence will be that the hematocrit measurement will take place first, followed by the simultaneous measurement of glucose and interference. In this strip 700 configuration, the hematocrit cathode 702 will be covered with glucose reagent and the hematocrit anode 706 will be reagent free. The i/i areas 707 on the strip are “isolation islands” that separate areas of no reagent (aH+aDD) from areas of reagent (aInt) or areas of two different reagents (aInt vs. cG+cInt+cDD).

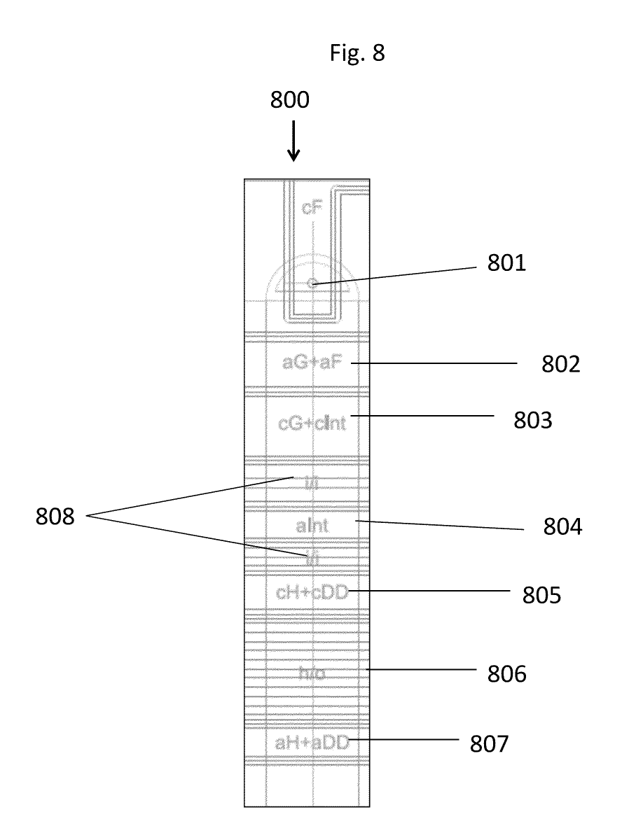

FIG. 8 illustrates an embodiment of a diagnostic strip 800 with a long Hct path, which may be provided for better resolution of the results, and which may further comprises a hog out region 806. The strip 800 comprises a fill cathode 801, a shared glucose and fill anode 802, a shared glucose and interference cathode 803, an interference anode 804 which may be coated with reagent only (mediator only), a shared drop detect and hematocrit cathode 805, a hog out region 806, a shared hematocrit and drop detect anode 807, and two isolation islands (i/i) 808.

The hog out region may measure from about 1.2 mm to 2.0 mm. In measuring the resistance of the blood over an electrically isolated region, the resistance of the blood is proportional to its hematocrit. If the hog out distance increases, different hematocrit levels may be better distinguished from each other as the longer distance increases the signal to noise ratio. With a small separation, the variability in the distance between the hematocrit anode and electrode can make up a larger percentage of the gap. As the gap gets larger the manufacturing tolerances get relatively smaller and the resolution may improve. It should be noted that, in some embodiments, the hog out region may be removed or is optional, as seen in FIGS. 4, 7 and 9.

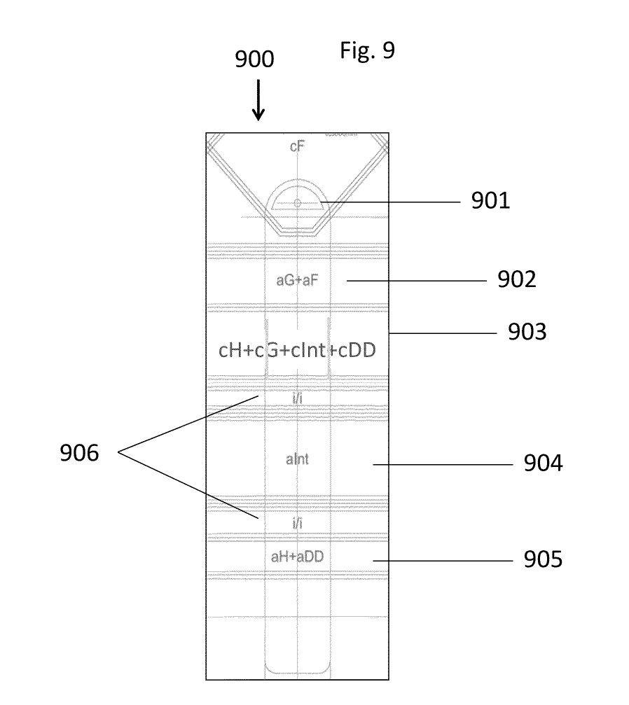

FIG. 9 illustrates an embodiment of a diagnostic strip 900 with a common Hct, glucose and interference cathode 903. The strip 900 comprises a fill cathode 901, a shared glucose and fill anode 902, a shared Hct, glucose, interference, and drop detect cathode 903, an interference anode 904, a shared Hct and drop detect anode 905, and two isolation islands (i/i) 906. As a result of the shared design of the strip 900, the strip 900 only has 5 total electrodes.

FIG. 10 illustrates a diagnostic strip 1000 with a well design for reagent containment. The strip 1000 comprises a fill cathode 1001, a shared glucose and interference cathode 1002, a glucose anode 1003, an interference anode 1004, a shared Hct and drop detect cathode 1005, a hog out region 1006, a shared Hct and drop detect anode 1007, and three wells for reagent containment. A first well 1008 contains glucose reagent. A second well 1009 contains interference reagent. A third well 1010 contains no reagent or a reagent with only small amounts of surfactant and/or polymer and/or buffer.

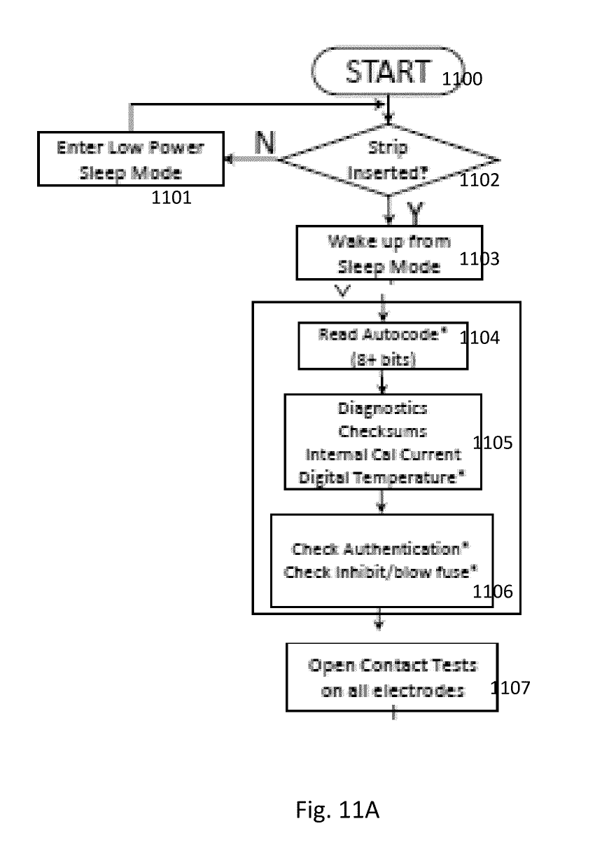

FIG. 11A and FIG. 11B illustrate a flow chart of an exemplary process 1100 for measuring analyte concentration using test strips of the present disclosure.

In reference to FIG. 11A and FIG. 11B, the meter may be battery powered and may stay in a low-power sleep mode 1101 when not in use in order to save power. When the test strip is inserted into the meter 1102, current flow to the meter causes the meter to wake up and enter an active mode 1103. Alternatively, the meter may be provided with a wake button.

Next, the meter can connect to the control circuit to read the code 1104 information from the control circuit and can then identify, for example, the particular test to be performed, or a confirmation of proper operating status. In addition, the meter can also identify the inserted strip as either a test strip or a check strip based on the particular code information. If the meter detects a check strip, it performs a check strip sequence 1105. If the meter detects a test strip, it performs a test strip sequence.

In addition, the meter can ensure that the test strip is authentic and has not been previously used 1106 and 1107. The meter will also measure the ambient temperature 1105. Diagnostics 1105 may include checksums or cyclic redundancy checks (CRC) of portions of the internal and/or external memory to establish confidence that the memory is not corrupted because the checksum/crc data calculated matches the programmed checksum/crc. In some embodiments, diagnostics test 1105 that may be performed is an LCD test to verify the integrity of the LCD to gain confidence it is not cracked and will display the proper result to the user that is sent to it. In some embodiments, diagnostic test 1105 may be an internal calibration current test to verify that the analog front end continues to measure an accurate current within the margin of error allowed.

If all information checks out, the meter can perform open contact tests on all electrodes to validate the electrodes 1107. The meter may validate the electrodes by confirming that there are no low-impedance paths between any of these electrodes. If the electrodes are valid, the meter indicates to the user 1108 that sample may be applied to the test strip and the meter can perform analyte measurements.

In some embodiments, the systems of the present disclosure may be used to measure glucose concentration in blood, among other measurements, as discussed above. Once the meter has performed an initial check routine 1104, 1105, 1106, 1107, as described above, the meter may apply a drop-detect voltage 1110 between a working and counter electrodes and detect a fluid sample, for example, a blood sample, by detecting a current flow between the working and counter electrodes (i.e., a current flow through the blood sample as it bridges the working and counter electrodes). For example, in some embodiments, the meter may measure an amount of components in blood which may impact the glucose measurement, such as, for example, a level of hematocrit 1111 or of an interferant 1111. The meter may later use such information to adjust the glucose concentration to account for the hematocrit level and the presence of the interferants in blood, among other things. These measurements may also be corrected based on the temperature.

Next, to detect that an adequate sample is present in the capillary chamber and that the blood sample has traversed the reagent layer and mixed with the chemical constituents in the reagent layer, the meter may apply a fill-detect voltage 1112 between the fill-detect electrodes and measure any resulting current flowing between the fill-detect electrodes. If this resulting current reaches a sufficient level within a predetermined period of time 1109, the meter indicates to the user that adequate sample is present and has mixed with the reagent layer. The process of adequate sample (fill) detection may occur at any time during the measurement sequence.

In one embodiment, the test strip meter comprises a decoder for decoding a predetermined electrical property, e.g. resistance, from the test strips as information. The decoder operates with, or is a part of, a microprocessor.

The meter can be programmed to wait for a predetermined period of time after initially detecting the blood sample 1109 or after ensuring there is adequate sample 1112, to allow the blood sample to react with the reagent layer or can immediately begin taking readings in sequence. During a fluid measurement period, the meter applies an assay voltage between the working and counter electrodes and takes one or more measurements of the resulting current flowing between the working and counter electrodes. The assay voltage is near the redox potential of the chemistry in the reagent layer, and the resulting current is related to the concentration of the particular constituent measured, such as, for example, the glucose level in a blood sample.

In one example, the reagent layer may react with glucose in the blood sample in order to determine the particular glucose concentration 1113. In one example, glucose oxidase is used in the reagent layer. The recitation of glucose oxidase is intended as an example only and other enzymes can be used without departing from the scope of the disclosure. Other possible mediators include, but are not limited to compounds containing ruthenium or osmium. During a sample test, the glucose oxidase initiates a reaction that oxidizes the glucose to gluconic acid and reduces the ferricyanide to ferrocyanide. When an appropriate voltage is applied to a working electrode, relative to a counter electrode, the ferrocyanide is oxidized to ferricyanide, thereby generating a current that is related to the glucose concentration in the blood sample. The meter then calculates the glucose level based on the measured current and on calibration data that the meter has been signaled to access by the code data read from the second plurality of electrical contacts associated with the test strip.

The meter can then adjust the glucose level 1115, as necessary, based on the measurements of the temperature, hematocrit and the presence of interferants 1111. Non-limiting examples of algorithms for glucose level correction are presented in FIG. 12 and FIG. 13. Errors will be displayed 1114 if encountered.

FIG. 12 discloses an embodiment flow chart for correcting the analyte value 1200, wherein the analyte specific current is modified based on temperature and hematocrit and interference currents to then generate a corrected analyte value. For example, equations may be IC=IA−S×II, where IC is the corrected current, IA is the current measured from the analyte anode, II is the current measured from the interference anode, and S is an empirically derived scaling factor. The present calculation may eliminate the need to make complicated calculation and/or voltage application schemes. The present calculation uses a mathematically modified (scaled) subtraction of the interference current from the current from the analyte specific anode. The interference current may be multiplied by an empirically determined constant that is dependent only on the relative areas of the two electrodes, not on the relative effects of hematocrit and temperature variations on the two currents. This is because the two reagents (analyte and interference) are formulated to respond the same way to hematocrit and temperature variations. Thus, referring to FIG. 12, the raw glucose signal 1201 would be corrected with the raw interference signal 1202 to obtain an interference corrected glucose signal 1203, where a temperature correction is incorporated to obtain an interference and temperature corrected glucose value 1204. The raw Hct signal 1205 is corrected to obtain a temperature corrected Hct 1206. The interference & temperature corrected glucose value 1204 may then be incorporated with the temperature corrected Hct 1206 to obtain an interference, temperature & Hct corrected glucose value 1207.

It is also possible to first make temperature and hematocrit adjustments to the interference current and then subtract it from the raw analyte current and then subject that corrected current to another temperature and hematocrit adjustment. In some embodiments, it may be possible to correct the analyte and interference currents separately for temperature and hematocrit, and then convert each separately to an uncorrected glucose value and to a glucose equivalent value, respectively. Then the glucose equivalent value can be subtracted from the uncorrected glucose value to obtain a corrected glucose value.

FIG. 13 discloses five potential non-limiting ways to use the current from the interference anode in combination with the current from the glucose anode to isolate the glucose signal. Both temperature and hematocrit affect both the interference and the glucose currents. In some embodiments, hematocrit and temperature effects are virtually identical for both currents primarily because the reagent composition of the glucose reagent and the interference reagent are so similar. The glucose reagent contains a glucose oxidoreductase (glucose dehydrogenase), which is a protein, while the interference reagent contains an inactive protein (which may be Bovine Serum Albumin) that mimics the physical properties (viscosity, solubility) of the enzyme in the reagent. This allows use of Correction ID #1 in FIG. 13. The reason that the scalar (constant) is included in Correction ID #1 is that the area of the interference anode is much larger than that of the glucose anode in order to increase the signal to noise ratio of the interference current. Accordingly, current from the interference anode is much lower than the current from the glucose anode. In some embodiments, the properties of the interference and glucose reagents are not so similar, which leads to use of a correction method such as Correction ID #2 or #3, which contain separate hematocrit and temperature corrections for the interference current and corrected analyte current or the raw analyte current. Correction ID #4 would be used in the case that the interference regent had different temperature properties than, but similar hematocrit properties to the glucose reagent. Correction ID #5 would be used in the case that the interference regent had different hematocrit properties than, but similar temperature properties to the glucose reagent.

In some embodiments, it is possible to use the present calculation to also first convert the interference current to analyte equivalents and then subtract it from the amount of analyte of interference and subtract that number. That is, the correction can occur before or after mathematically processing the current. For example, by having the interference anode larger for improved signal to noise ratio due to the currents being so small, at least one aspect includes using a scaling factor and anodes of different surface area.

In some embodiments, the type of subtraction may be made conditional on the level of interference. For example, if the level of interference is low enough relative the analyte, then no subtraction is necessary. However, if the interference level proves to be sufficiently high, then the subtraction can be made to correct the reported analyte value. At least one aspect of the interference correction is to improve the accuracy of the reported glucose value by cancelling the effect of interfering substances. However, when subtracting two currents (or two calculated values) each with a certain amount of noise it is possible to increase the precision error. For example, at a very low level of interference where the accuracy correction is minimal, it is possible to not subtract out the interference correction because improvement in accuracy can be outweighed by the degradation in precision. For example the FDA may desire that the glucose readings from glucose measuring devices report glucose values within ±7 mg/dL of the reference method for reference values≦70 mg/dL, and within ±10% for reference values>70 mg/dL, no less than 99% of the time. It may be decided that the total system error is minimized when the interference correction is made only when it amounts to a change of >3.5 mg/dL when the reference value is ≦70 mg/dL and only when it is >5% of the uncorrected glucose value when the reference value >70 mg/dL. However, at least one aspect considers to use cut off values of when the interference correction will be applied by determining which cut off values minimize the total system error. (TSE) At least one way of defining TSE is: TSE=|% Bias|+2×CV or |Bias (mg/dL)|+2×SD.

In some embodiments, the algorithm may use current subtraction. Current subtraction works as follows: In some embodiments, the interference anode is larger than the glucose anode because the interference anode current is typically small and a larger surface area is needed to improve the signal to noise ratio. Since the areas of the interference and glucose anodes are different, a simple equation will be used to modify the measured current from the interference anode to resize it correspond to that from the glucose anode: iInt Resize=m*iInt Raw+b. Where m & b are constants. Where m<1 and it is very likely that b=0, but that is not necessary. The resized current can be mathematically processed in a number of ways to yield a Corrected Interference Current: 1) no further correction is made; 2) a temperature correction is made (if the interference reagent changes with temperature in a manner different from that of the glucose reagent); 3) a hematocrit correction is made (if the interference reagent changes with hematocrit in a manner different from that of the glucose reagent); and 4) temperature and hematocrit corrections are made (if the interference reagent changes with temperature AND with hematocrit in ways different from that of the glucose reagent). At this point the corrected current from the interference anode is subtracted from the current from the glucose anode to get a current that represent the current from the oxidation of glucose alone. This current in turn is subjected to temperature correction, hematocrit correction and finally to a mathematic conversion to get a glucose value. The final mathematical conversion is typically (but not necessarily) in the form of a polynomial such as: Glucose=a*i2+b*1+c, where a, b & c are constants that can be tailored for each strip lot or where a, b & c are selected from a limited number of predetermined sets of such constants that best fit the strip lot in question.

In some embodiment, it may be possible to process the interference current as in Step 4) in the paragraph above and then apply a separate polynomial equation to the interference current to convert it to a glucose equivalent. This glucose equivalent will be subtracted from a glucose value derived from applying a temperature correction and a hematocrit correction to the glucose current and then applying a mathematical conversion to obtain a glucose value. This glucose value will be uncorrected for interference until the glucose equivalent is subtracted from it. The exact nature of all the possibilities of temperature and hematocrit corrections are numerous and should remained undefined. The meter then displays the calculated glucose level to the user.

It should be noted that while the operation of the system of the present disclosure has been described primarily in connection with determining glucose concentration in blood, the systems of the present disclosure may be configured to measure other analytes in blood as well as in other fluids, as discussed above.

Whereas many alterations and modifications of the present disclosure will no doubt become apparent to a person of ordinary skill in the art after having read the foregoing description, it is to be understood that the particular embodiments shown and described by way of illustration are in no way intended to be considered limiting. Further, the disclosure has been described with reference to particular embodiments, but variations within the spirit and scope of the disclosure will occur to those skilled in the art. It is noted that the foregoing examples have been provided merely for the purpose of explanation and are in no way to be construed as limiting of the present disclosure. While the present disclosure has been described with reference to exemplary embodiments, it is understood that the words, which have been used herein, are words of description and illustration, rather than words of limitation. Changes may be made, within the purview of the appended claims, as presently stated and as amended, without departing from the scope and spirit of the present disclosure in its aspects. Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A test strip comprising:
a base layer;
a hematocrit anode disposed on the base layer and configured to determine a value corresponding to a hematocrit level of a fluid sample, wherein the hematocrit anode is free of a reagent;
an interference anode disposed on the base layer and configured to determine a value corresponding to a measurement of an interference caused by one or more oxidizable substances in the sample fluid, wherein the interference anode electrode includes an interference reagent on its surface;
a glucose anode disposed on the base layer, the glucose anode being configured to determine a glucose level in the fluid sample, wherein the glucose anode is covered with a reagent comprising a mediator and an analyte specific enzyme; and
one or more cathodes in a cooperative relation with the hematocrit anode, the interference anode, and the glucose anode to measure the hematocrit level, the interference and the glucose level.

2. The test strip of claim 1, wherein the strip further comprises a proximal end closer to the fluid sample, and an opposing distal end, and wherein the hematocrit anode is most proximal, the glucose anode is most distal, and the interference anode is positioned between the hematocrit anode and the glucose anode.

3. The test strip of claim 1, wherein the one or more cathodes comprises a hematocrit cathode, an interference cathode, and a glucose cathode, all of which are disposed on the base layer in close proximity to the hematocrit anode, the interference anode and the glucose anode respectively.

4. The test strip of claim 1, wherein the one or more cathodes comprises a hematocrit cathode and a second cathode, wherein the second cathode is shared by the interference anode and the glucose anode.

5. The test strip of claim 1, wherein the one or more cathodes is a single cathode shared by the hematocrit anode, the interference anode, and the glucose anode, the single cathode having a full reagent deposited on upon its surface, and wherein the hematocrit level is measured before the measurement of interference or the determination of the glucose level.

6. The test strip of claim 1, wherein the mediator is potassium ferricyanide or ruthenium hexaammine, and wherein the analyte specific enzyme is glucose oxidase or glucose dehydrogenase.

7. The test strip of claim 1, wherein the one or more cathodes comprises a hematocrit cathode, the test strip having a measurement path between the hematocrit anode and the hematocrit cathode of from about 0.5 mm to about 5 mm.

8. The test strip of claim 7, wherein the hematocrit anode and the hematocrit cathode are separated by an electrically isolated region.

9. The test strip of claim 1, wherein a surface of the interference cathode further comprises a reagent containing an analyte specific enzyme.

10. The test strip of claim 1, wherein the hematocrit anode is shared with a drop detect anode, the shared anode being located at a proximal end of the strip, wherein a drop detect cathode is shared with the glucose cathode and the interference cathode, and wherein the strip further comprises at least one isolation island configured to separate regions of reagents from regions of no reagent.

11. The test strip of claim 1, further comprising at least one hog out region.

12. The test strip of claim 1, further comprising one or more isolation islands, the isolation islands configured to separate regions of the strip with a reagent from regions of the strip without a reagent, or to separate regions of the strip with a reagent from regions of the strip with a different reagent.

13. The test strip of claim 1, further comprising at least one reagent well and a multi-well spacer in which a reagent is drop dispensed.

14. The test strip of claim 1, wherein the hematocrit anode is most proximal, the glucose anode is most distal, and the interference anode is positioned between the hematocrit anode and the glucose anode.

15. A system for measuring glucose concentration comprising:
a test strip comprising a base layer; a hematocrit anode disposed on the base layer and configured to determine a value corresponding to a hematocrit level of the fluid sample, wherein the hematocrit anode is free of a reagent; an interference anode disposed on the base layer and configured to determine a value corresponding to a measurement of an interference caused by one or more oxidizable substances in the sample fluid, wherein the interference anode electrode includes an interference reagent on its surface; a glucose anode is disposed on the base layer, the glucose anode electrode is configured to determine a glucose level in the fluid sample; and one or more cathodes in a cooperative relation with the anodes to measure hematocrit level, interference and glucose level; and
a test meter configured to accept the test strip, the test meter configured to apply a voltage between the anodes and the one or more cathodes, measure current corresponding to hematocrit level, glucose level and interference, and determine a glucose concentration based on the detected currents.

16. The system of claim 15, wherein the test strip further comprises at least one hog out region.

17. The system of claim 15, wherein the test strip further comprises one or more isolation islands, the isolation islands configured to separate regions of the strip with a reagent from regions of the strip without a reagent, or to separate regions of the strip with a reagent from regions of the strip with a different reagent.

18. A method for measuring an amount of glucose in a sample of blood comprising:
measuring a hematocrit value in a sample of blood placed onto a test strip, wherein the test strip comprises a base layer; a hematocrit anode disposed on the base layer and configured to determine a value corresponding to a hematocrit level of the fluid sample, wherein the hematocrit anode is free of a reagent; an interference anode disposed on the base layer and configured to determine a value corresponding to a measurement of an interference caused by one or more oxidizable substances in the sample fluid, wherein the interference anode electrode includes an interference reagent on its surface; a glucose anode is disposed on the base layer, the glucose anode electrode is configured to determine a glucose level in the fluid sample; and one or more cathodes in a cooperative relation with the anodes to measure hematocrit level, interference and glucose level;
measuring an amount of glucose in the sample;
determining an amount of interference from one or more interferents present in the sample; and
calculating, with the meter, a final glucose value in the sample by adjusting the measured amount of glucose with both the measured hematocrit value and the determined amount of interference.

19. The method of claim 18, wherein the hematocrit value is measured by applying a voltage with the meter to a pair of hematocrit electrodes; wherein the amount of glucose is measured by applying a voltage with the meter to a pair of glucose electrodes; and wherein the amount of interference is determined by applying a voltage with the meter to a pair of interference electrodes.

20. The method of claim 18, wherein the test strip is inserted into a test meter, the test meter being configured to accept the test strip, the test meter configured to apply a voltage between the anodes and the one or more cathodes, measure current corresponding to hematocrit level, glucose level and interference, and determine a glucose concentration based on the detected currents.
